(19) United States
(12) Patent Application Publication
(10) Pub. No.: US 2016/0012124 A1
(43) Pub. Date: Jan. 14, 2016

(54) METHODS FOR AUTOMATIC QUERY TRANSLATION

(71) Applicants: Jean-David Ruvini, Los Gatos, CA (US); Hassan Sawaf, Los Gatos, CA (US)

(72) Inventors: Jean-David Ruvini, Los Gatos, CA (US); Hassan Sawaf, Los Gatos, CA (US)

(21) Appl. No.: 14/328,428

(22) Filed: Jul. 10, 2014

(51) Int. Cl. G06F 17/30; G06Q 30/02

(52) U.S. Cl. CPC G06F 17/30669; G06F 17/30864; G06Q 30/0201

(57) ABSTRACT

User-specific queries for items may be collected from a search engine in language A and corresponding behavioral data with respect to items returned for the queries, such as items viewed, watched, liked, clicked, and bought by the user may also be collected. Similar data may be gathered for user specific queries from a search engine in language B. For query pairs, each in a different language, the system may measure the similarity of their user behavioral data using language independent features such as images, UPC codes, price, seller, category, and the like, and using translated features such as descriptors that comprise keywords that describe the items returned in response to the queries. Those pairs of queries in the two languages with high similarity of user behavior are statistically translations of each other.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### TECHNICAL FIELD

The present application relates generally to electronic commerce and, in one specific example, to mining parallel search engine queries from search engine user behavioral data.

### BACKGROUND

The use of mobile devices, such as cellphones, smartphones, tablets, and laptop computers, has increased rapidly in recent years, which, along with the rise in dominance of the Internet as the primary mechanism for communication, has caused an explosion in electronic commerce (“ecommerce”). As these factors spread throughout the world, communications between users that utilize different spoken or written languages increase exponentially. Ecommerce has unique challenges when dealing with differing languages being used, specifically an ecommerce transaction often involves the need to ensure specific information is accurate. For example, if a potential buyer asks a seller about some aspect of a product for sale, the answer should be precise and accurate. Any failing in the accuracy of the answer could result in a lost sale or an unhappy purchaser.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram illustrating marketplace and payment applications and that, in one example embodiment, are provided as part of application server(s) in the networked system.

FIG. 3 is a block diagram illustrating an example machine translation module.

FIG. 4 is a block diagram illustrating a method in accordance with an example embodiment.

FIG. 5 is a block diagram illustrating a mobile device, according to an example embodiment.

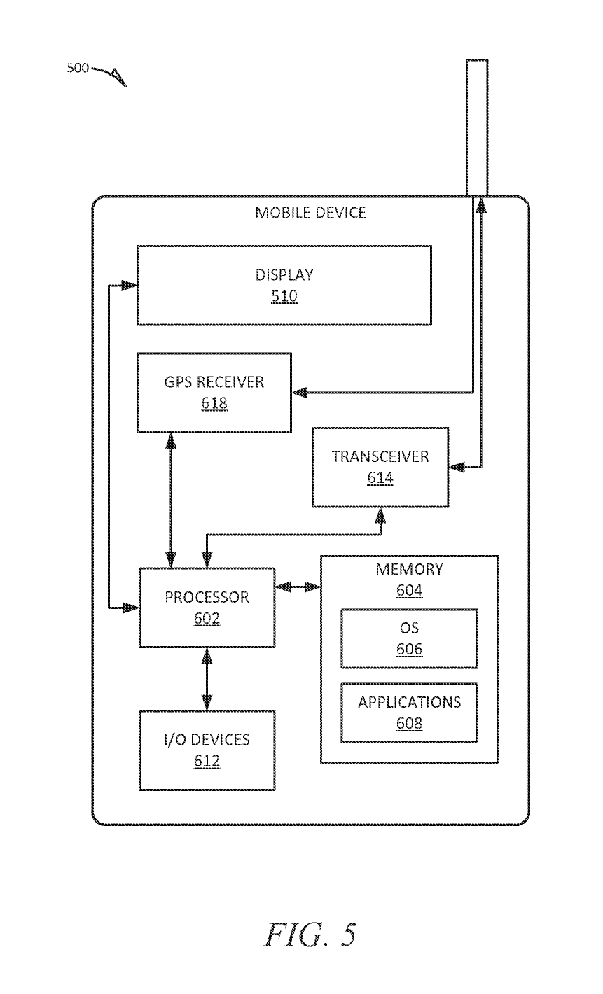

FIG. 6 is a block diagram of a machine in the example form of a computer system within which instructions may be executed for causing the machine to perform any one or more of the methodologies discussed herein.

### DETAILED DESCRIPTION

Example methods and systems for machine translation are provided. It will be evident, however, to one skilled in the art that the present inventive subject matter may be practiced without these specific details.

Machine translation is a subfield of computational linguistics that investigates the use of software to translate text or speech from one natural language to another. Machine translation relies heavily on parallel corpora, for example, translated documents, but acquiring parallel corpora is a very time consuming and expensive, particularly domain specific corpora like ecommerce system data. Consequently, automated translation is desired.

According to various exemplary embodiments, user specific queries for items may be gathered or collected from a search engine in language A (e.g., English) and corresponding behavioral data such as, for items that returned in response to the query, the items viewed, watched, liked, clicked, bought by the user, and the like, and, in one embodiment, a count of how many users acted on the items. Similar data may be gathered for user specific queries from a search engine in language B (e.g., French). For query pairs, each in a different language, the system may measure the similarity of their user behavior data. This may be done using language independent features such as images, UPC codes, price, seller, category, and the like. Those pairs of queries in the two languages with high similarity of user behavior are potentially translations of each other. Individual query/behavioral data for queries in each language may be organized into feature vectors and the foregoing similarity may be measured by use of a distance function to determine similarity, or “closeness” of query pairs. Query pairs with the high similarity may be used as respective statistical translations of each other. Stated another way, an estimate of likelihood of query pairs being translations of each other may be based on the foregoing measure of similarity of the feature vectors. The foregoing may be accomplished by using historical data sets from an online system such as an ecommerce system, which may include millions of user queries in different languages. As used herein, a query and the behavioral data for items that are returned for the query may be referred to as query data.

The system may also measure queries resulting in fuzzy matches, which may not be an actual match but still exhibit similarities. Likewise, similar color densities in the histogram of a pair of items may also indicate a similarity. Given that a color histogram is a set of real numbers, “same color densities” may occur only for identical pictures. Hence “similar color density histograms.” where similarity could be measured, for example, as the ordering of colors when sorted from highest to lowest density is a more practical metric.

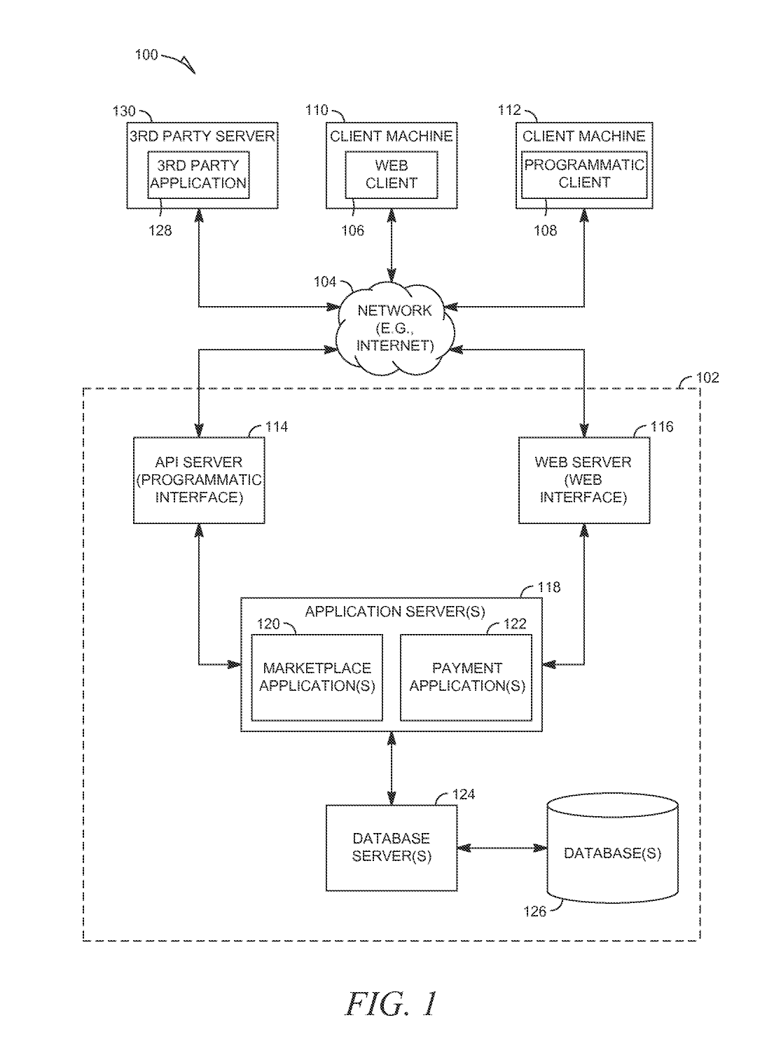

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)), to one or more clients. FIG. 1 illustrates, for example, a web client 106 (e.g., a browser, such as the Internet Explorer browser developed by Microsoft Corporation of Redmond, Wash. State) and a programmatic client 108 executing on respective devices 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102.

The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

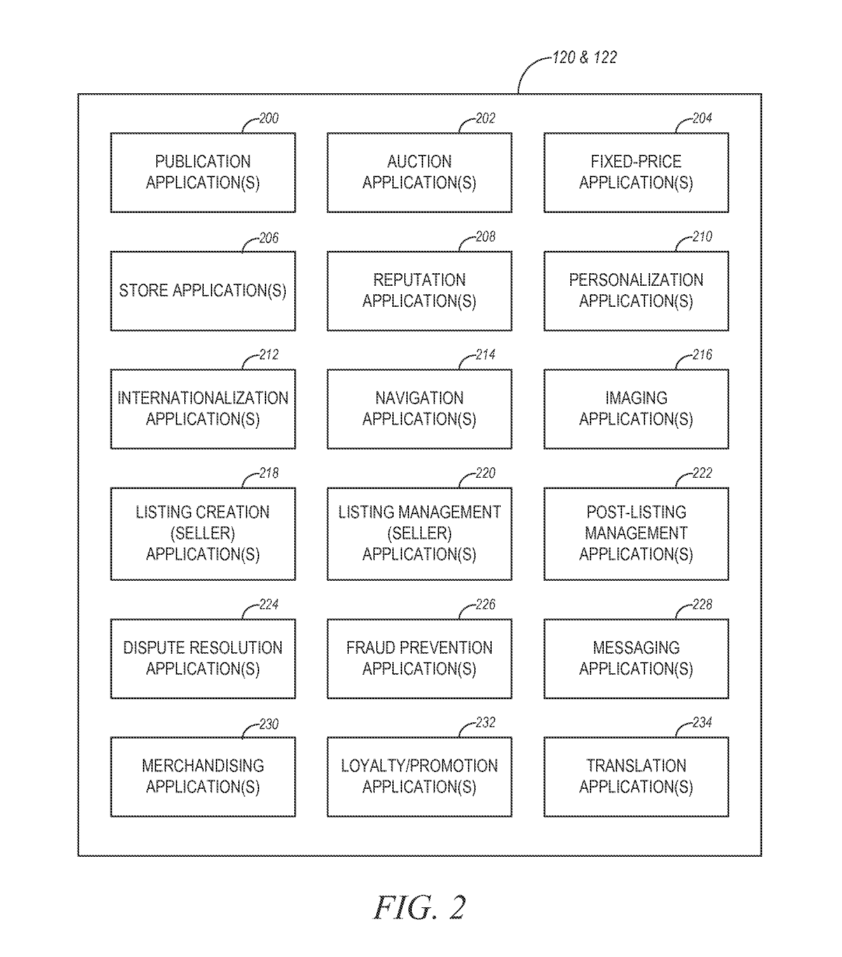

FIG. 2 is a block diagram illustrating marketplace and payment applications 120 and 122 that, in one example embodiment, are provided as part of application server(s) 118 in the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions, etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information by the networked system 102) according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users)). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks 104.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

A machine translation application 234 may develop parallel corpora from user behavior by mining parallel search engine queries in different languages. For example, user specific queries for items may be gathered from a search engine in language A (e.g., English) and corresponding behavioral data such as, for items that are responsive to the query, the items viewed, watched, liked, clicked, bought by the user, and the like, and, in one embodiment, a count of how many users acted on the items. Similar data may be gathered for user specific queries from a search engine in language B (e.g., French). For query pairs, each in a different language, the system may measure the similarity of their user behavior data. An estimate of likelihood of query pairs being translations of each other may be based on a measure of similarity of the query pairs as discussed in additional detail below.

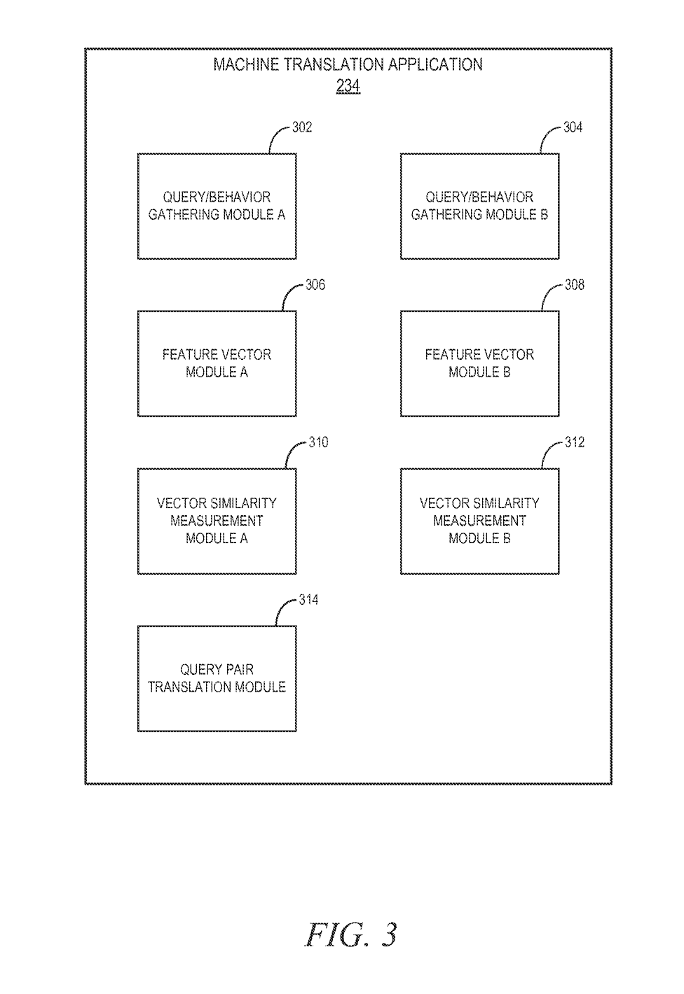

FIG. 3 is a block diagram illustrating an example of machine translation module 234. The machine translation module may comprise query/behavior gathering module A (i.e., for language A) 302, query/behavior gathering module B (i.e., for language B) 304, feature vector module A 306, feature vector module B 308, vector similarity measurement module A 310, vector similarity measurement module B 312, and query pair translation module 314. Generally, and for clarification purposes, a machine translation system may comprise considerably more than a single module to generate parallel data. Once parallel data are collected, a sequence of steps may be carried out by a machine translation system to produce a statistical translation of queries in language A to respective queries in language B.

In additional detail, a system may gather user specific queries from data sets of a search engine in language A (e.g., eBay.com) along with the corresponding behavioral data in response to items returned for the query. This behavioral data may include a list of items viewed, watched, liked, clicked, bought, and the like, by the user. The same query will likely appear multiple times with different behavioral data because 1) different users may exhibit different behavior for the same query and 2) the items presented may be different at different points in time. Similar data (queries and respective behavioral data) may be gathered from data sets of a search engine in language B (e.g., eBay.fr). These functions may be accomplished by query/behavior gather modules 302 and 304 of FIG. 3 for language A and language B, respectively.

For both language A and language B, each query data may be converted into a single feature vector. In pattern recognition and machine learning, a feature vector is an n-dimensional vector of numerical features that represent some object. Many algorithms in machine learning require a numerical representation of objects, since such representations facilitate processing and statistical analysis. When representing images, the feature values might correspond to the pixels of an image, when representing texts perhaps to term occurrence frequencies. Feature vectors are equivalent to the vectors of explanatory variables used in statistical procedures such as linear regression. Feature vectors are often combined with weights using, in one example embodiment, a dot product in order to construct a linear predictor function that is used to determine a score for making a prediction. The single feature vector for each query, for language A and for language B, respectively, may be formed. A vector may be a positive real number summing to one. For example, a vector with five features may be [0.1, 0.1, 0.05, 0.25, 0.5], the sum of the features being 1.0. Assuming the queries were issued to find Visio HD television sets, the feature names could be: [Vizio, HD, TV, 1080p, LED].

One type of feature comprises translation invariant features such as image features, UPC code, price, category information, model numbers, brand names, attributes and values, seller id, country of origin, and the like. In some cases, features may be extracted from the queries themselves. For example, consider the English query “Vizio, HD TV” and the French query “Vizio, HD têlêvision.” The keywords Vizio and HD are translation invariant and are good features to use to identify that these two queries are translations of each other. Embodiments for collecting such translation invariant features may be found in U.S. Patent Application Ser. No. 61/946,640, filed Feb. 28, 2014 and entitled “Methods for Automatic Generation of Parallel Corpora” which is hereby incorporated herein by reference in its entirety.

Another type of feature comprises translated features such as a translation of some descriptors of the behavioral data in the language, for language A or language B. These descriptors may be the keywords describing the items, such as title, subtitle and description, item specifics, and the like. The numerical value of each feature of a feature vector may be a function of how many users clicked on the corresponding item for that query, most likely in the form of a probability. Each click may be seen as an event. The probability of a feature for a given query can be computed as the ratio of the number of clicks received for that feature to the total numbers clicks received for that query data. Translated features may be limited to the top most significant keywords if translation resources are limited. Forming feature vectors results in two sets of unique queries, one in language A, one in language B, each with a (potentially very large) feature vector. Features that appear in only one language may be ignored.

A measurement method may be employed for each pair of queries (one from language A, one from language B) to measure the similarity of their feature vectors. Pairs of queries with a high similarity (i.e. for which users behave very similarly in language A and B) are potential translations of each other. As to the amount of similarity needed, the similarity does not necessarily have to be passed through a threshold because a machine translation system can accommodate confidence information in its training data. Also, a threshold can be tuned based on iterative translation quality evaluations on test data as part of the machine translation training process.

The above measurement method may involve multiple steps. These comprise (1) designing a distance function (i.e. the reverse of a similarity function); (2) computing a pairwise distance matrix; and (3) for every query in one language, searching for the nearest query in the other language. A distance function is a function that defines a distance between elements of a metric space. Theoretically a distance function satisfies the non-negativity, identity of indiscernible, symmetry, and triangle inequality axioms. In the context of machine translation, the distance function may be a function of two feature vectors and searching for the nearest query in language B to a query in language A means searching for the closest feature vector, in terms of distance, in language B.

The distance function may operate on two feature vectors and return a real value. If the feature vectors are identical, the value is 0, the more dissimilar, the larger the real value. One commonly use distance function is the weighted sum of the differences between the value of the features:

$${\sum }_{i = 1}^{F} {w}_{i .} \vert {f}_{i}^{A} ( q ) - {f}_{i}^{B} ( q ) \vert$$

Where F is the total number of features, fᵢ^{L} (q) is the value of feature i for query q in language L. Weights may be defined for reach feature vector and the term w is the weight given to each element of the feature vector. The weights may be set so that the translation invariant features have much more impact in the distance function than the other features. Some domain knowledge, for example, a priori knowledge about good indicators of translations, may be used to assess the value of the weights. For instance, one may observe that model numbers are particularly important to identify that two queries are translation of each other.

Alternatively, machine learning techniques may be used to optimize the weights automatically. This may require providing the algorithm with training examples, that is, pairs of queries that are similar and pairs of queries that are not similar.

In one embodiment kernel functions may be used. Using kernel functions allows computing similarity in theoretical projection of the feature vectors in other high dimensional spaces (even infinite with Gaussian kernels). Again, machine learning methods exist to optimize such distance functions.

In another embodiment computing the pairwise similarity matrix of feature vectors may be used. Computing the pairwise similarity matrix amounts to computing the distance for pairs of queries across languages. Once the distance function has been established, the distance between all pairs of queries across languages may be computed. The process can scale millions of queries and very large feature vectors as the time complexity is in the order of the square of the number of queries.

In yet another embodiment searching for the most similar query can employ data structures like a k-d-tree (or k-dimensional tree) or an octree data structure may be used to solve this step. Assuming there are N queries in language A and M queries in language B, the computing time would be of the order of M*log (N) (assuming M<N). Alternatively, locality sensitive hashing may be used. Locally sensitive hashing is a well-studied stochastic hashing method such that similar objects have a very high probability to be assigned the same hashcode.

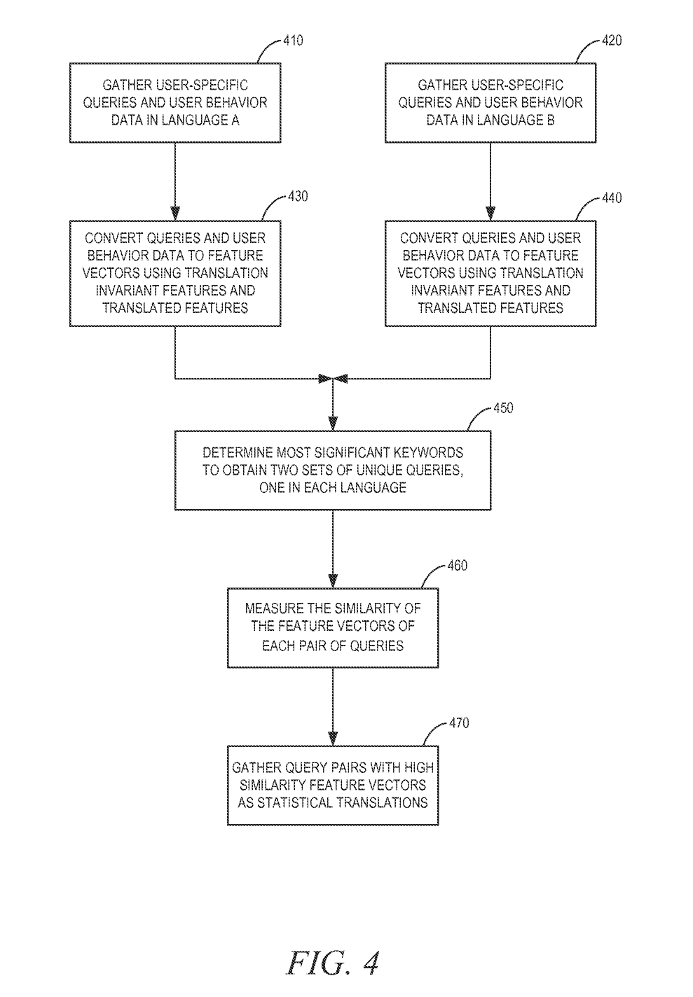

FIG. 4 is a block diagram illustrating a method in accordance with an example embodiment. At 410 and 420 the system may gather user specific quarries and user behavior data in each language, language A and Language B, respectively. This may be accomplished by user specific query/behavior gathering module A and user specific query/behavior gathering module B, respectively items 302 and 304 of FIG. 3. As mentioned previously, this may be accomplished using historical system data sets of queries, their returned items, and user behavior with respect to the returned items.

The query data in the respective languages may be converted, at 430 and 440, to feature vectors as discussed above using feature vector module A and feature vector module B, respectively items 306 and 308 of FIG. 3. This may be accomplished using translation invariant features and translated features as discussed above.

At 450 the most significant keywords may be determined to obtain two sets of unique queries, one in each language, to obtain two sets of unique queries in each language. Step 450 may be needed if resources (e.g., memory, disk space, computing time) are constrained. So, this is not about the significance of keywords but of features. For instance, only the N features with the highest probability can be retained.

At 460 the similarity of the feature vectors of each pair of queries may be measured. This may be accomplished by vector similarity measurements module A and vector similarity measure module B, respectively items 310 and 312 of FIG. 3 for the respective languages. As discussed above, this measurement process may use a distance function and compute a pairwise distance matrix; then for every query in one language, searching for the nearest query in the other language.

At 470 the queries of query data pairs with high similarity feature vectors, as measured from the similarity measurement of 460, may be gathered to be used as respective statistical translations of each other. This data can be then added to the training set of the machine translation system as training examples, which typically consist of sentence pairs. In this case a query is treated as a sentence.

### Example Mobile Device

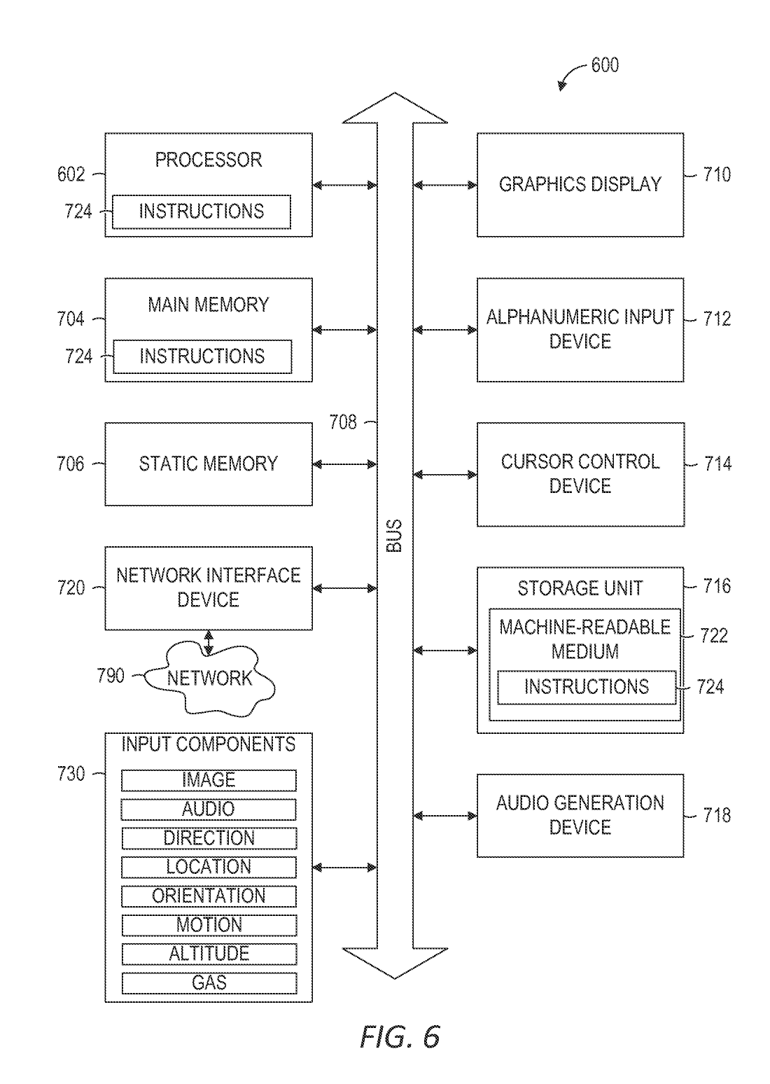

FIG. 6 is a block diagram illustrating a mobile device 600, according to an example embodiment. The mobile device 600 may include a processor 602. The processor 602 may be any of a variety of different types of commercially available processors suitable for mobile devices (for example, an XScale architecture microprocessor, a microprocessor without interlocked pipeline stages (MIPS) architecture processor, or another type of processor 602). A memory 604, such as a random access memory (RAM), a flash memory, or other type of memory, is typically accessible to the processor 602. The memory 604 may be adapted to store an operating system (OS) 606, as well as application programs 608, such as a mobile location enabled application that may provide LBSs to a user. The processor 602 may be coupled, either directly or via appropriate intermediary hardware, to a display 610 and to one or more input/output (I/O) devices 612, such as a keypad, a touch panel sensor, a microphone, and the like. Similarly, in some embodiments, the processor 602 may be coupled to a transceiver 614 that interfaces with an antenna 616. The transceiver 614 may be configured to both transmit and receive cellular network signals, wireless data signals, or other types of signals via the antenna 616, depending on the nature of the mobile device 600. Further, in some configurations, a GPS receiver 618 may also make use of the antenna 616 to receive GPS signals.

### Modules, Components and Logic

Certain embodiments are described herein as including logic or a number of components, modules, or mechanisms. Modules may constitute either software modules (e.g., code embodied (1) on machine-readable storage or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors 602 may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure processor 602, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors 602 that are temporarily configured (e.g., by software) or permanently configured to perform the relevant operations. Whether temporarily or permanently configured, such processors 602 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 602 or processor-implemented modules. The performance of certain of the operations may be distributed among the one or more processors 602, not only residing within a single machine, but deployed across a number of machines. In some example embodiments, the processor 602 or processors 602 may be located in a single location (e.g., within a home environment, an office environment or as a server farm), while in other embodiments the processors 602 may be distributed across a number of locations.

The one or more processors 602 may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 602, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors 602 executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 602), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 6 is a block diagram of machine in the example form of a computer system 700 within which instructions 724 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard or a touch-sensitive display screen), a user interface (UI) navigation (e.g., cursor control) device 714 (e.g., a mouse), a disk drive unit 716, a signal generation device 718 (e.g., a speaker) and a network interface device 720.

### Machine-Readable Medium

The disk drive unit 716 includes a computer-readable medium 722, which may be hardware storage, on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting computer-readable media 722.

While the computer-readable medium 722 is shown in an example embodiment to be a single medium, the term “computer-readable medium” may include a single medium or multiple media (e.g., a centralized or distributed database, and/or associated caches and servers) that store the one or more instructions 724 or data structures. The term “computer-readable medium” shall also be taken to include any tangible medium that is capable of storing, encoding or carrying instructions 724 for execution by the machine and that cause the machine to perform any one or more of the methodologies of the present disclosure or that is capable of storing, encoding or carrying data structures utilized by or associated with such instructions 724. The term “computer-readable medium” shall accordingly be taken to include, but not be limited to, solid-state memories, and optical and magnetic media. Specific examples of computer-readable media 722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 724 for execution by the machine, and includes digital or analog communications signals or other intangible media to facilitate communication of such software.

Although the inventive subject matter has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of translating queries comprising:
collecting query data in a first language, the query data in the first language comprising queries for items and user behavioral data with respect to items returned in response to the queries;
collecting query data in a second language, the query data in the second language comprising queries in the second language for items and user behavioral data with respect to items returned in response to the queries in the second language;
for query data pairs comprising query data in the first language and query data in the second language, measuring, by at least one computer processor, the similarity of the user behavioral data of the respective query data of the query data pairs;
determining respective pairs of queries in the first language and queries in the second language that have high similarity of user behavioral data to each other; and
using the determined respective pairs of queries as statistical translations of each other.

2. The method of claim 1 wherein the query data in the first language are converted to first feature vectors and the query data in the second language are converted to second feature vectors, and the measuring the similarity of the user behavioral data of the respective query data of the query data pairs comprises measuring the similarity of the first feature vectors to second feature vectors.

3. The method of claim 2 wherein the determining respective pairs of queries that have high similarity of user behavioral data to each other comprises computing a pairwise distance matrix for the feature vectors of the queries and, for respective first feature vectors, searching for the most similar second feature vector.

4. The method of claim 2 wherein the first feature vectors and the second feature vectors comprise translation invariant features and translated features.

5. The method of claim 4 wherein the translation invariant features comprise at least one of UPC code, price, category information, model numbers, brand names, attributes, seller identification, or country of origin of the items returned in response to the queries.

6. The method of claim 4 wherein the translated features comprise descriptors that comprise keywords that describe the items returned in response to the queries.

7. The method of claim 1 wherein the query data comprises queries issued by one of a mobile communication device, a laptop, or a stationary communication device.

8. One or more computer-readable hardware storage device having embedded therein a set of instructions which, when executed by one or more processors of a computer, causes the computer to execute operations comprising:
collecting query data in a first language, the query data in the first language comprising queries for items and user behavioral data with respect to items returned in response to the queries;
collecting query data in a second language, the query data in the second language comprising queries in the second language for items and user behavioral data with respect to items returned in response to the queries in the second language;
for query data pairs comprising query data in the first language and query data in the second language, measuring, by at least one computer processor, the similarity of the user behavioral data of the respective query data of the query data pairs;
determining respective pairs of queries in the first language and queries in the second language that have high similarity of user behavioral data to each other; and
using the determined respective pairs of queries as statistical translations of each other.

9. The one or more computer-readable hardware storage device of claim 8 wherein the query data in the first language are converted to first feature vectors and the query data in the second language are converted to second feature vectors, and the measuring the similarity of the user behavioral data of the respective query data of the query data pairs comprises measuring the similarity of the first feature vectors to the second feature vectors.

10. The one or more computer-readable hardware storage device of claim 9 wherein the determining respective pairs of queries that have high similarity of user behavioral data to each other comprises computing a pairwise distance matrix for the feature vectors of the queries and, for respective first feature vectors, searching for the most similar second feature vector.

11. The one or more computer-readable hardware storage device of claim 9 wherein the feature vectors comprise translation invariant features and translated features.

12. The one or more computer-readable hardware storage device of claim 11 wherein the translation invariant features comprise at least one of UPC code, price, category information, model numbers, brand names, attributes, seller identification, or country of origin of the items returned in response to the queries.

13. The one or more computer-readable hardware storage device of claim 11 wherein the translated features comprise descriptors that comprise keywords that describe the items returned in response to the queries.

14. The one or more computer-readable hardware storage device of claim 8 wherein the query data comprises queries issued by one of a mobile communication device, a laptop, or a stationary communication device.

15. A system for translating queries comprising:
one or more computer processors and storage configured to execute
a query/behavior gathering module for collecting query data in a first language, the query data in the first language comprising queries for items and user behavioral data with respect to items returned in response to the queries;
a query/behavior gathering module collecting query data in a second language, the query data in the second language comprising queries in the second language for items and user behavioral data with respect to items returned in response to the queries in the second language;
a vector similarity measurement module that, for query data pairs comprising query data in the first language and query data in the second language, measures the similarity of the user behavioral data of the respective query data of the query data pairs; and
a query pair translation module for determining respective pairs of queries in the first language and queries in the second language that have high similarity of user behavioral data to each other, and using the determined respective pairs of queries as statistical translations of each other.

16. The system of claim 15 wherein the one or more computer processors and storage are further configured to execute feature vector modules to convert the query data in the first language to first feature vectors and the query data in the second language to second feature vectors, and the measuring the similarity of the user behavioral data of the respective query data of the query data pairs comprises measuring the similarity of the first feature vectors to the second feature vectors.

17. The system of claim 16 wherein the determining respective pairs of queries that have high similarity of user behavioral data to each other comprises computing a pairwise distance matrix for the feature vectors of the queries and, for respective first feature vectors, searching for the most similar second feature vector.

18. The system of claim 16 wherein the feature vectors comprise translation invariant features and translated features.

19. The system of claim 18 wherein the translation invariant features comprise at least one of UPC code, price, category information, model numbers, brand names, attributes, seller identification, or country of origin of the items returned in response to the queries.

20. The system of claim 18 wherein the translated features comprise descriptors that comprise keywords that describe the items returned in response to the queries.
